(19) United States
(12) Patent Application Publication
(10) Pub. No.: US 2019/0324693 A1
(43) Pub. Date: Oct. 24, 2019

(54) STORAGE DEVICE AND OPERATING METHOD THEREOF

(71) Applicant: SK hynix Inc., Gyeonggi-do (KR)

(72) Inventors: Seung Gu JI, Seoul (KR); Ik Joon SON, Gyeonggi-do (KR)

(21) Appl. No.: 16/388,207

(22) Filed: Apr. 18, 2019

Related U.S. Application Data
(60) Provisional application No. 62/660,082, filed on Apr. 19, 2018.

(30) Foreign Application Priority Data
Feb. 25, 2019 (KR) 10-2019-0022090

(51) Int. Cl. G06F 3/06; G06F 12/0842

(52) U.S. Cl. CPC G06F 3/0659; G06F 3/0604; G06F 2212/1008; G06F 12/0842; G06F 3/068

(57) ABSTRACT

A memory control having improved cache program operation performance controls a memory device. The memory controller includes: a command queue for sequentially storing commands to be executed by the memory device; a cache program determinerfor determining, when a first command that is a program command stored in the command queue is provided to the memory device, whether a second command to be executed next in time to the first command is a program command; and a program operation controller for controlling the memory device to perform a program operation according to the first command as a normal program operation or cache program operation, depending on whether the second command is a program command.

### CROSS-REFERENCE TO RELATED APPLICATIONS

The present application claims benefit under 35 U.S.C. § 119(e) of U.S. Provisional Application No. 62/660,082, filed on Apr. 19, 2018 in the United States Patent and Trademark Office, and benefit under 35 U.S.C. § 119(a) of Korean patent application number 10-2019-0022090, filed on Feb. 25, 2019 in the Korean Intellectual Property Office, the entire disclosures of which are incorporated by reference herein.

### BACKGROUND

### Field of Invention

The present disclosure generally relates to an electronic device, and more particularly, to a storage device and an operating method thereof.

### Description of Related Art

A storage device stores data under the control of a host device such as a computer or a smart phone. The storage device may include a memory device for storing data and a memory controller for controlling the memory device. The memory device may be a volatile memory device or a nonvolatile memory device.

A volatile memory device stores data only when power is supplied, which data disappears when the supply of power is interrupted. A volatile memory device may include a static random access memory (SRAM), a dynamic random access memory (DRAM), and the like.

A nonvolatile memory device retains data even when the supply of power is interrupted. A nonvolatile memory device may include a read only memory (ROM), a programmable ROM (PROM), an electrically programmable ROM (EPROM), an electrically erasable ROM (EPROM), a flash memory, and the like.

### SUMMARY

Embodiments provide a storage device having improved cache program operation performance and an operating method thereof.

According to an aspect of the present disclosure, there is provided a memory controller for controlling a memory device, the memory controller including: a command queue configured to sequentially store commands to be executed by the memory device; a cache program determiner configured to determine, when a first command that is a program command stored in the command queue is provided to the memory device, whether a second command to be executed next in time to the first command is a program command; and a program operation controller configured to control the memory device to perform a program operation according to the first command as a normal program operation or cache program operation, depending on whether the second command is a program command.

According to another aspect of the present disclosure, there is provided a method for operating a memory controller that controls a memory device and includes a command queue for sequentially storing commands to be executed by the memory device, the method including: providing the memory device with a program initiation command indicating initiation of a program operation corresponding to a first command that is a program command stored in the command queue; and controlling the memory device to perform a program operation according to the first command as a normal program operation or cache program operation depending on whether a second command to be executed next in time to the first command is a program command.

According to still another aspect of the present disclosure, there is provided a storage device including: a memory device including a plurality of memory cells; and a memory controller configured to sequentially store commands to be executed by the memory device, provide the memory device with a first command that is a program command among the commands to be executed, and control the memory device to perform a program operation according to the first command as a normal program operation or cache program operation, depending on whether a second command to be executed next in time to the first command is a program command.

### BRIEF DESCRIPTION OF THE DRAWINGS

Various embodiments will now be described more fully with reference to the accompanying drawings; however, elements and features of the present invention may be configured or arranged differently than disclosed herein. Thus, the present invention is not limited to the embodiments set forth herein. Rather, these embodiments are provided so that this disclosure is thorough and complete and fully conveys the scope of the embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout. Also, throughout the specification, reference to “an embodiment,” “another embodiment” or the like is not necessarily to only one embodiment, and different references to any such phrase are not necessarily to the same embodiment(s).

FIG. 1 is a diagram illustrating a storage device according to an embodiment of the present disclosure.

FIG. 2 is a diagram illustrating a structure of a memory device, is such as that shown in FIG. 1.

FIG. 3 is a diagram illustrating an embodiment of a memory cell array, such as that shown in FIG. 2.

FIG. 4 is a circuit diagram illustrating an example of a memory block among memory blocks shown in FIG. 3.

FIG. 5 is a circuit diagram illustrating another example of a memory block among the memory blocks shown in FIG. 3.

FIG. 6 is a diagram illustrating an operation of a memory device and a memory controller according to an embodiment of the present disclosure.

FIG. 7 is a diagram illustrating a command queue, such as that shown in FIG. 6.

FIG. 8 is a diagram ustrating a normalprogram operation and a cache program operation.

FIG. 9 is a diagram illustrating a program operation according to an embodiment of the present disclosure.

FIG. 10 is a diagram illustrating a program operation according to another embodiment of the present disclosure.

FIG. 11A is a diagram illustrating a normal program operation, such as that shown in FIG. 10.

FIG. 11B is a diagram illustrating a cache program operation, such as that shown in FIG. 10.

FIG. 12 is a flowchart illustrating an operation of a memory controller according to an embodiment of the present disclosure.

FIG. 13 is a flowchart illustrating in detail the operation of a memory controller, such as that shown in FIG. 12.

FIG. 14 is a flowchart illustrating an operation of a memory device according to an embodiment of the present disclosure.

FIG. 15 is a diagram illustrating a memory controller according to an embodiment of the present disclosure.

FIG. 16 is a block diagram illustrating a memory card system to which the storage device is applied according to an embodiment of the present disclosure.

FIG. 17 is a block diagram illustrating a solid state drive (SSD) system to which the storage device is applied according to an embodiment of the present disclosure.

FIG. 18 is a block diagram illustrating a user system to which the storage device is applied according to an embodiment of the present disclosure.

### DETAILED DESCRIPTION

The specific structural and functional description herein is directed to embodiments of the present disclosure. The embodiments, however, can be implemented in various ways and with various configurations to form other embodiments, and thus the present invention is not to be construed as limited to the embodiments set forth herein.

While the disclosed embodiments are illustrated and described in detail, the present invention is not limited to specific details or by specific terminology. Rather, the present invention includes all changes, equivalents, or substitutes that do not depart from the spirit and technical scope of the present disclosure.

While terms such as “first” and “second” may be used to identify various components, such components are limited by the above terms. The above terms are used only to distinguish one component from another that otherwise have the same or similar names. For example, a first component may be referred to as a second component, and vice versa, without departing from the scope of rights of the present disclosure.

It will be understood that when an element is referred to as being “connected” or “coupled” to another element, it can be directly connected or coupled to the other element or one or more intervening elements may also be present. In contrast, when an element is referred to as being “directly connected” or “directly coupled” to another element, no intervening elements are present. Other expressions describing relationships between components such as “˜ between,” “immediately ˜ between” or “adjacent to ˜” and “directly adjacent to ˜” may be construed similarly.

Singular forms in the present disclosure are intended to include the plural forms as well, unless the context clearly indicates otherwise. It will be further understood that open-ended terms such as “including” or “having,” etc., are intended to indicate the existence of the stated features, numbers, operations, actions, components, parts, or combinations thereof, and are not intended to preclude the possibility that one or more other features, numbers, operations, actions, components, parts, or combinations thereof may exist or may be added.

So far as not being differently defined, all terms used herein including technical or scientific terminologies have meanings that they are commonly understood by those skilled in the art to which the present disclosure pertains. Ordinary dictionary-defined terms should be understood such that they have meanings consistent with the context of the related technique. So far as not being clearly defined in this application, terms should not be understood in an ideally or excessively formal way.

In describing embodiments, description of techniques that are well known to the art hich the present disclosure pertains and not directly related to the present disclosure is omitted. This intends to avoid unnecessarily obscuring aspects of the present invention.

Various embodiments of the present disclosure will be described in detail with reference to the accompanying drawings in order for those skilled in the art to be able to readily implement the present invention.

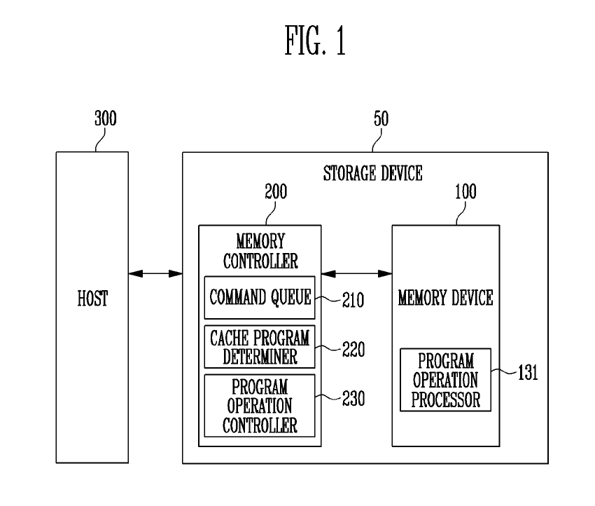

FIG. 1 is a diagram illustrating a storage device 50 according to an embodiment of the present disclosure.

Referring to FIG. 1, the storage device 50 may include a memory device 100 and a memory controller 200 for controlling an operation of the memory device 100. The storage device 50 may store data under the control of a host 300, such as a mobile phone, a smart phone, an MP3 player, a laptop computer, a desktop computer, a game console, a television (TV), a tablet personal computer (PC) or an in-vehicle infotainment.

The storage device 50 may be configured as any of various types of storage devices according to a host interface that is a communication scheme with the host 300. For example, the storage device 50 may be implemented with any of various types of storage devices, such as a multi-media card of a Solid State Drive (SSD), a Multi-Media Card (MMC), an embedded, Multi-Media Card (eMMC), a Reduced Size, Multi-Media Card (RS-MMC), and a micro-Multi-Media Card (micro-MMC) type, a Secure Digital (SD) card of a Secure Digital (SD), a mini-Secure Digital (mini-SD) and a micro-Secure Digital (micro-SD) type, an Universal Serial Bus (USB) storage device, a Universal Flash Storage (UFS) device, a storage device of a Personal Computer Memory Card International Association (PCMCIA) card type, a storage device of a Peripheral Component Interconnection (PCI) card type, a storage device of a PCI-Express (PCI-e or PCIe) card type, a Compact Flash (CF) card, a smart media card, and a memory stick.

The storage device 50 may be manufactured as any of various kinds of package types. For example, the storage device 50 may be manufactured as any of a Package-on-Package (PoP), a System-in-Package (SIP), a System-on-Chip (SoC), a Multi-Chip Package (MCP), a Chip-On-Board (COB), a Wafer-level Fabricated Package (WFP), and a Wafer-level Stack Package (WSP).

The memory device 100 may store data. The memory device 100 operates under the control of the memory controller 200. The memory device 100 may include a memory cell array including a plurality of memory cells for storing data.

Each of the memory cells may be a single level cell (SLC) for storing one data bit, a multi-level cell (MLC) for storing two data bits, a triple level cell (TLC) for storing three data bits, or a quad level cell (QLC) for storing four data bits.

The memory cell array may include a plurality of memory blocks. Each memory block may include a plurality of memory cells. One memory block may include a plurality of pages. In an embodiment, the page may be a unit for storing data in the memory device 100 or reading data stored in the memory device 100. The memory block may be a unit for erasing data. In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM or ReRAM), a Phase-Change Random Access Memory (PRAM), a Magnetoresistive Random Access Memory (MRAM), a Ferroelectric Random Access Memory (FRAM), a Spin Transfer Torque Random Access Memory (STT-RAM), or the like. In the context of the present disclosure, the memory device 100 is described, by way of example, as a NAND flash memory.

The memory device 100 receives a command and an address from the memory controller 200 and accesses an area selected by the address in the memory cell array. That is, the memory device 100 may perform an operation corresponding to the command on the area selected by the address. For example, the memory device 100 may perform a write (or program) operation, a read operation, and an erase operation. In the program operation, the memory device 100 may program data in the area selected by the address. In the read operation, the memory device 100 may read data from the area selected by the address. In the erase operation, the memory device 100 may erase data stored in the area selected by the address.

The memory device 100 may perform a normal program operation. The normal program operation may be a program operation of storing, in the memory cell array, data that the memory device 100 receives from the memory controller 200. In the normal program operation, the memory device 100 cannot receive new data from the memory controller 200 while the memory device 100 is performing a program operation of storing data in the memory cell array. Therefore, the memory device 100 may receive new data from the memory controller 200 after the program operation of storing data in the memory cell array is completed.

The memory device 100 may perform a cache program operation. In the cache program operation, the memory device 100 may receive new data from the memory controller 200 while the memory device 100 is performing a program operation of storing data in the memory cell array. Therefore, when consecutive write data is stored, the cache program operation may be performed more rapidly than the normal program operation.

In an embodiment, the memory device 100 may include a program operation processor 131.

The program operation processor 131 may perform a program operation of storing data received from the memory controller 200 in the memory cell array in response to a program initiation command provided by the memory controller 200. When a program operation is performed, the program operation processor 131 may perform the normal program operation or the cache program operation according to a program type command provided by the memory controller 200.

The memory controller 200 may control overall operations of the storage device 50.

When power is applied to the storage device 50, the memory controller 200 may execute firmware (FW). When the memory device 100 is a flash memory device, the memory controller 200 may execute FW such as a flash translation layer (FTL) for controlling communication between the host 300 and the memory device 100.

In an embodiment, the memory controller 200 may receive data and a logical block address (LBA) from the host 300, and translate the LBA into a physical block address (PBA) representing one or more addresses of memory cells included in the memory device 100, in which data is to be stored.

The memory controller 200 may control the memory device 100 to perform a program operation, a read operation, or an erase operation in response to a request from the host 300. In the program operation, the memory controller 200 may provide a program command, a PBA, and data to the memory device 100. In the read operation, the memory controller 200 may provide a read command and a PBA to the memory device 100. In the erase operation, the memory controller 200 may provide an erase command and a PBA to the memory device 100.

In an embodiment, the memory controller 200 may autonomously generate a program command, an address, and data, in the absence of a request from the host 300, and transmit the program command, the address, and the data to the memory device 100. For example, the memory controller 200 may provide the command, the address, and the data to the memory device 100 to perform background operations such as a program operation for wear leveling and a program operation for garbage collection.

In an embodiment, the memory controller 200 may control at least two memory devices 100. The memory controller 200 may control the memory devices according to an interleaving scheme so as to improve operational performance. The interleaving scheme may be an operating scheme that allows the memory devices 100 to perform operations or portions thereof in parallel with each other.

In an embodiment, the memory controller 200 may include a command queue 210, a cache program determiner 220, and a program operation controller 230.

The command queue 210 may sequentially store a plurality of commands to be executed by the memory device 100. The stored command may be any one of a read command, a program command, and an erase command. The command may be generated according to a request of the host 300. The commands stored in the command queue 210 may be performed by the memory device 100 in the sequence in which they are generated. That is, the commands stored in the command queue 210 may be managed using a first-in first-out (FIFO) scheme.

The cache program determiner 220 may determine whether a command to be executed next or subsequent in time to a program command provided to the memory device 100, among consecutive commands sequentially stored in the command queue 210, is a program command. Thus, reference to any command being executed “next to” any other command indicates next in time. The cache program determiner 220 may generate command information representing whether such command is a program command. The cache program determiner 220 may provide the generated command information to the program operation controller 230.

The program operation controller 230 may determine whether a command stored in the command queue 210 is a program command. When the stored command is a program command, the program operation controller 230 may provide the memory device 100 with a program initiation command according to the program command. The program operation controller 230 may provide the memory device 100 with a program type command corresponding to the program initiation command.

The program initiation command may instruct the memory device 100 to perform a program operation of storing data. The program type command may represent whether a program operation to be performed by the memory device 100 is a normal program operation or cache program operation.

In an embodiment, when the program operation to be performed by the memory device 100 is the normal program operation, the program type command may indicate a first type. When the program operation to be performed by the memory device 100 is the cache program operation, the program type command may indicate a second type.

The program operation controller 230 may sequentially provide the memory device 100 with the program initiation command, an address of the memory device 100, at which data is to be stored, the data, and the program type command. In another embodiment, the sequence in which the program initiation command and the data are provided to the memory device 100 may be reversed.

For example, when a first command between consecutive first and second commands sequentially stored in the command queue 210 is a program command, the program operation controller 230 may provide the program initiation command to the memory device 100 according to the first (program) command. The second command may be executed next to the first command by the memory device 100.

The program operation controller 230 may receive, from the cache program determiner 220, command information representing whether the second command is a program command. When the second command is the program command according to the command information, the program operation controller 230 may control the memory device 100 to perform the cache program operation. When the second command is a read command or erase command according to the command information, the program operation controller 230 may control the memory device 100 to perform the normal program operation.

Specifically, the program operation controller 230 may determine a program type command corresponding to the program initiation command according to the command information. When the second command is the read command or erase command according to the command information, the program operation controller 230 may determine the program type command to indicate the first type. When the second command is the program command according to the command information, the program operation controller 230 may determine the program type command to indicate the second type.

The program operation controller 230 may provide the determined program type command to the memory device 100. The memory device 100 may perform a program operation according to the first command as the normal program operation or cache program operation according to the program type command provided thereto.

In an embodiment, when the program type command indicates the first type, the memory device 100 may perform the normal program operation in the program operation according to the first command. Therefore, after the memory device 100 completes the normal program operation according to the first command, the program operation controller 230 may provide the memory device 100 with data to be stored according to another program command.

When the program type command indicates the second type, the memory device 100 may perform the cache program operation in the program operation according to the first command. Therefore, while the memory device 100 is performing the cache program operation according to the first command, the program operation controller 230 may provide the memory device 100 with data to be stored according to the second command.

The host 300 may communicate with the storage device 50 using at least one of various communication protocols, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

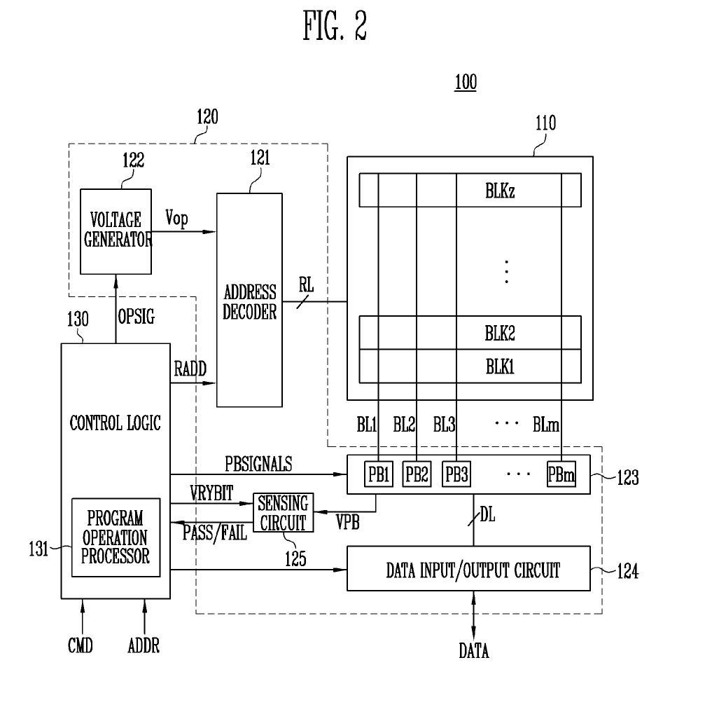

FIG. 2 is a diagram illustrating a structure of the memory device 100 shown in FIG. 1.

Referring to FIG. 2, the memory device 100 may include a memory cell array 110, a peripheral circuit 120, and control logic 130. The peripheral circuit 120 may include an address decoder 121, a voltage generator 122, a read and write (read/write) circuit 123, a data input and output (input/output) circuit 124, and a sensing circuit 125.

The memory cell array 110 includes a plurality of memory blocks BLK1 to BLKz. The plurality of memory blocks BLK1 to BLKz are coupled to the address decoder 121 through row lines RL. The plurality of memory blocks BLK1 to BLKz are coupled to the read/write circuit 123 through bit lines BL1 to BLm. Each of the plurality of memory blocks BLK1 to BLKz includes a plurality of memory cells.

In an embodiment, the plurality of memory cells may be nonvolatile memory cells. Among the plurality of memory cells, memory cells coupled to the same word line may be defined as one page. That is, the memory cell array 110 may include a plurality of pages. According to an embodiment of the present disclosure, each of the plurality of memory blocks BLK1 to BLKz included in the memory cell array 110 may include a plurality of dummy cells. One or more dummy cells may be coupled in series between a drain select transistor and memory cells, and between a source select transistor and the memory cells.

Each of the memory cells of the memory device 100 may be a single level cell (SLC) for storing one data bit, a multi-level cell (MLC) for storing two data bits, a triple level cell (TLC) for storing three data bits, or a quad level cell (QLC) for storing four data bits.

The peripheral circuit 120 drives the memory cell array 110. For example, the peripheral circuit 120 may drive the memory cell array 110 to perform a program operation, a read operation, and an erase operation.

The address decoder 121 is coupled to the memory cell array 110 through the row lines RL. The row lines RL may include drain select lines, word lines, source select lines, and a common source line. According to an embodiment of the present disclosure, the word lines may include normal word lines and dummy word lines. According to an embodiment of the present disclosure, the row lines RL may further include a pipe select line.

The address decoder 121 may operate under the control of the control logic 130. The address decoder 121 receives a row address RADD from the control logic 130.

The address decoder 121 may decode a block address in the received row address RADD. The address decoder 121 selects at least one memory block among the memory blocks BLK1 to BLKz according to the decoded block address. The address decoder 121 rr ay select at least one word line WL of the selected memory block by applying voltages provided from the voltage generator 122 to the word line WL according to the decoded row address RADD.

In a program operation, the address decoder 121 may apply a program voltage to the selected word line, and apply a pass voltage having a level lower than that of the program voltage to unselected word lines. In a program verify operation, the address decoder 121 may apply a verify voltage to the selected word line, and apply a verify pass voltage having a level higher than that of the verify voltage to the unselected word lines.

In a read operation, the address decoder 121 may apply a read voltage to the selected word line, and apply a read pass voltage having a level higher than that of the read voltage to the unselected word lines.

According to an embodiment of the present disclosure, an erase operation of the memory device 100 is performed in units of memory blocks. In an erase operation, the address ADDR input to the memory device 100 includes a block address. The address decoder 121 may decode the block address and select one memory block according to the decoded block address. In the erase operation, the address decoder 121 may apply a ground voltage to word lines coupled to the selected memory block.

According to an embodiment of the present disclosure, the address decoder 121 may decode a column address in the address ADDR transmitted thereto. The decoded column address may be transmitted to the read/write circuit 123. In an example, the address decoder 121 may include components such as a row decoder, a column decoder, and an address buffer.

The voltage generator 122 may generate a plurality of voltages by using an external power voltage supplied to the memory device 100. The voltage generator 122 operates under the control of the control logic 130.

In an embodiment, the voltage generator 122 may generate an internal power voltage by regulating the external power voltage. The internal power voltage generated by the voltage generator 122 is used as an operation voltage of the memory device 100.

In an embodiment, the voltage generator 122 may generate a plurality of operating voltages Vop by using the external power voltage or the internal power voltage. The voltage generator 122 may be configured to generate various voltages required by the memory device 100. For example, the voltage generator 122 may generate a plurality of erase voltages, a plurality of program voltages, a plurality of pass voltages, a plurality of select read voltages, and a plurality of unselect read voltages.

In order to generate a plurality of operating voltages Vop having various voltage levels, the voltage generator 122 may include a plurality of pumping capacitors for receiving the internal power voltage, and generate the plurality of operating voltages Vop by selectively activating the plurality of pumping capacitors under the control of the control logic 130.

The plurality of operating voltages Vop may be supplied to the memory cell array 110 by the address decoder 121.

The read/write circuit 123 includes first to mth page buffers PB1 to PBm. The first to mth page buffers PB1 to PBm are coupled to the memory cell array 110 through the respective first to mth bit lines BL1 to BLm. The first to mth page buffers PB1 to PBm operate under the control of the control logic 130.

The first to mth page buffers PB1 to PBm communicate data DATA with the data input/output circuit 124. In a program operation, the first to mth page buffers PB1 to PBm receive data DATA to be stored through the data input/output circuit 124 and data lines DL.

In a program operation, the first to mth page buffers PB1 to PBm may transfer, to selected memory cells through the bit lines BL1 to BLm, data DATA received through the data input/output circuit 124 when a program pulse is applied to a selected word line. The selected memory cells are programmed according to the transferred data DATA. A memory cell coupled to a bit line through which a program allow voltage (e.g., a ground voltage) is applied may have an increased threshold voltage. A threshold voltage of a memory cell coupled to a bit line through which a program inhibit voltage (e.g., a power voltage) is applied may be maintained. In a program verify operation, the first to mth page buffers PB1 to PBm read data DATA stored in the selected memory cells, from the selected memory cells through the bit lines BL1 to BLm.

In a read operation, the read/write circuit 123 may read data DATA from memory cells of a selected page through the bit lines BL, and store the read data DATA in the first to mth page buffers PB1 to PBm.

In an erase operation, the read/write circuit 123 may float the bit lines BL. In an embodiment, the read/write circuit 123 may include a column select circuit.

In an embodiment, in a cache program operation, while a program operation of storing, in the memory cell array 110, data DATA stored in some page buffers among a plurality of page buffers included in the read/write circuit 123 is being performed, other page buffers among the plurality of page buffers may receive new data DATA from the data input/output circuit 124 and store the received new data DATA.

In an embodiment, the read/write circuit 123 may include page buffers and cache page buffers. The cache page buffers may temporarily store data DATA input from the memory controller 200 during the cache program operation. That is, while a program operation of storing data DATA stored in the page buffers in the memory cell array 110 is being performed, the cache page buffers may temporarily store the data DATA input from the memory controller 200. When the program operation is completed, the data DATA stored in the page buffers may be erased. When the program operation is completed, the page buffers may receive the data DATA stored in the cache page buffers and store the received data DATA.

The data input/output circuit 124 is coupled to the first to mth page buffers PB1 to PBm through the data lines DL. The data input/output circuit 124 operates under the control of the control logic 130.

The data input/output circuit 124 may include a plurality of input/output buffers that receive input data DATA. In a program operation, the data input/output circuit 124 may receive data DATA to be stored from an external controller (e.g., the memory controller 200 of FIG. 1). In a read operation, the data input/output circuit 124 outputs, to the external controller, data transmitted from the first to mth page buffers PB1 to PBm included in the read/write circuit 123.

In a read operation or verify operation, the sensing circuit 125 may generate a reference current in response to an allow bit VRYBIT signal generated by the control logic 130. Further, the sensing circuit 125 may output a pass signal or fail signal to the control logic 130 by comparing a sensing voltage VPB received from the read/write circuit 123 and a reference voltage generated by the reference current.

The control logic 130 may be coupled to the address decoder 121, the voltage generator 122, the read/write circuit 123, the data input/output circuit 124, and the sensing circuit 125. The control logic 130 may control overall operations of the memory device 100. The control logic 130 may operate in response to a command CMD transferred from an external device (e.g., the memory controller 200 of FIG. 1).

The control logic 130 may control the peripheral circuit 120 by generating several signals in response to a command CMD and an address ADDR. For example, the control logic 130 may generate an operation signal OPSIG, a row address RADD, a read/write circuit control signal PBSIGNALS, and an allow bit VRYBIT in response to the command CMD and the address ADDR. The control logic 130 may output the operation signal OPSIG to the voltage generator 122, output the row address RADD to the address decoder 121, output the read/write circuit control signal PBSIGNALS to the read/write circuit 123, and output the allow bit VRYBIT to the sensing circuit 125. Also, the control logic 130 may determine whether the verify operation has passed or failed in response to the pass or fail signal PASS/FAIL output by the sensing circuit 125.

In an embodiment, the control ogic 130 may include a program operation processor 131.

The program operation processor 131 may receive, from the memory controller 200, a program command CMD such as a program initiation command and a program type command, and an address ADDR of the memory cell array 110, at which program data is to be stored.

The program operation processor 131 may perform a program operation of storing program data DATA received by the data input/output circuit 124 in the memory cell array 110 via the read/write circuit 123, in response to the received program initiation command CMD.

Specifically, the program operation processor 131 may transfer the program data received by the data input/output circuit 124 to a plurality of page buffers included in the read/write circuit 123 through the data lines DL. The plurality of page buffers may store the program data DATA transferred from the data input/output circuit 124. The plurality of page buffers may be electrically coupled to the memory cell array 110 through the bit lines BL. The program operation processor 131 may perform a program operation of storing the program data DATA stored in the plurality of page buffers in the memory cell array 110, based on the received address ADDR.

In the program operation of storing the program data DATA in the memory cell array 110, the program operation processor 131 may perform a normal program operation or cache program operation according to the received program type command CMD.

When the program operation processor 131 performs the normal program operation, the program operation processor 131 may control the read/write circuit 123 to receive new program data DATA after the program operation of storing the program data DATA in the memory cell array 110 is completed. When the program operation processor 131 performs the cache program operation, the program operation processor 131 may control the read/write circuit 123 to receive new program data DATA, while the program operation of storing the program data DATA in the memory cell array 110 is being performed.

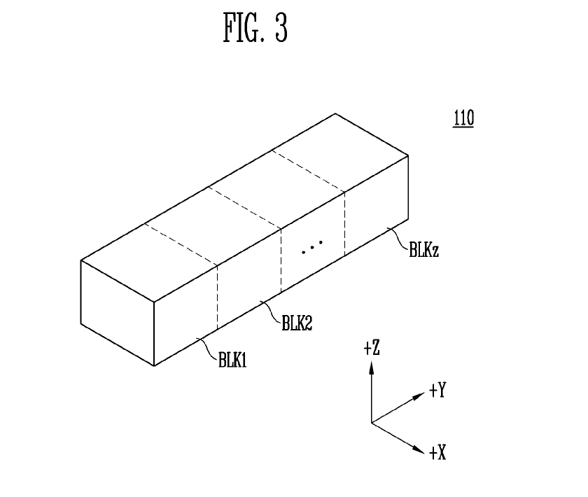

FIG. 3 is a diagram illustrating an embodiment of the memory cell array 110 shown in FIG. 2.

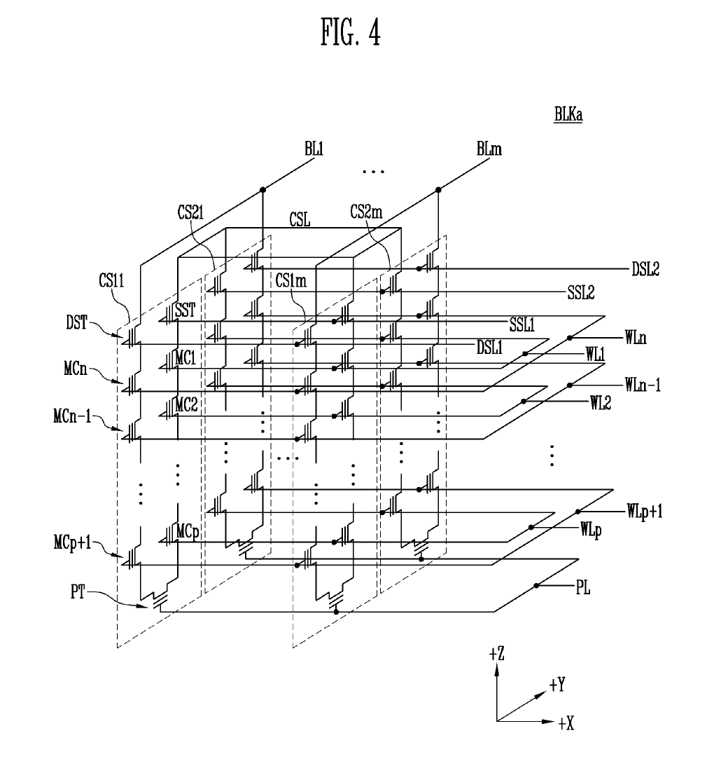

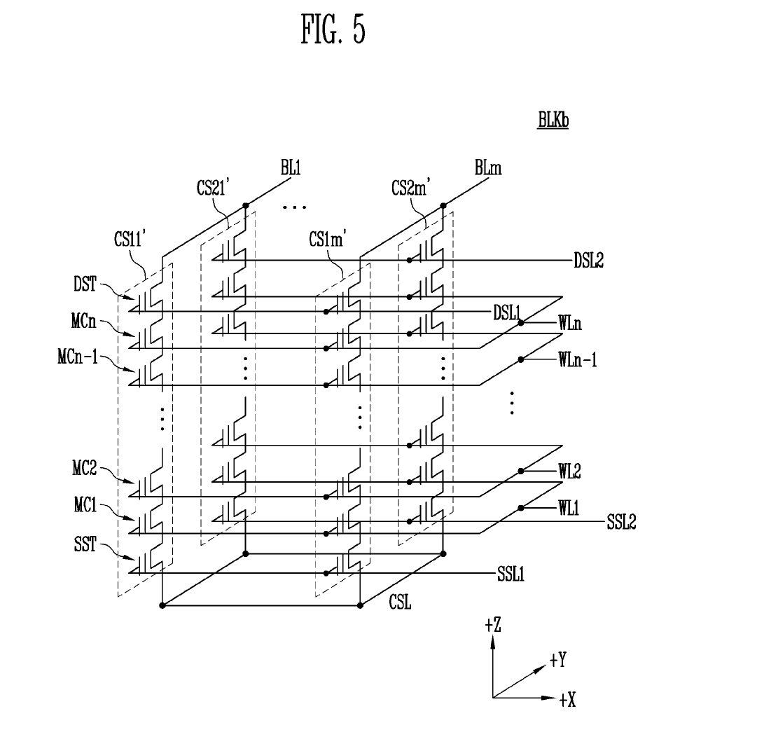

Referring to FIG. 3, the memory cell array 110 may include a plurality of memory blocks BLK1 to BLKz, Each memory block may have a three-dimensional structure. Each memory block may include a plurality of memory cells stacked on a substrate (not shown). The plurality of memory cells may be arranged along +X, +Y, and +Z directions. A structure of each memory block will be described in more detail with reference to FIGS. 4 and 5.

FIG. 4 is a circuit diagram illustrating an example of a memory block BLKa, among the memory blocks BLK1 to BLKz, shown in FIG. 3.

Referring to FIG. 4, the memory block BLKa may include a plurality of cell strings CS11 to CS1m and CS21 to CS2m. In an embodiment, each of the plurality of cell strings CS11 to CS1m and CS21 to CS2m may be formed in a ‘U’ shape. In the memory block BLKa, m cell strings are is arranged in a row direction (i.e., a +X direction). Although FIG. 4 illustrates two cell strings arranged in a column direction (i.e., a +Y direction), it will be understood that three cell strings may be arranged in the column direction.

Each of the plurality of cell strings CS11 to CS1m and CS21 to CS2m may include at least one source select transistor SST, first to nth memory cells MC1 to MCn, a pipe transistor PT, and at least one drain select transistor DST.

The select transistors SST and DST and the memory cells MC1 to MCn may have structures similar to one another. In an embodiment, each of the select transistors SST and DST and the memory cells MC1 to MCn may include a channel layer, a tunneling insulating layer, a charge storage layer, and a blocking insulating layer. In an embodiment, a pillar for providing the channel layer may be provided in each cell string. In an embodiment, a pillar for providing at least one of the channel layer, the tunneling insulating layer, the charge storage layer, and the blocking insulating layer may be provided in each cell string.

The source select transistor SST of each cell string is coupled between a common source line CSL and memory cells MC1 to MCp.

In an embodiment, the source select transistors of cell strings arranged on the same row are coupled to a source select line extending in the row direction, and the source select transistors of cell strings arranged on different rows are coupled to different source select lines. In FIG. 4, the source select transistors of the cell strings CS11 to CS1m on a first row are coupled to a first source select line SSL1. The source select transistors of the cell strings CS21 to CS2m on a second row are coupled to a second source select line SSL2.

In another embodiment, the source select transistors of the cell strings CS11 to CS1m and CS21 to CS2m may be commonly coupled to one source select line.

The first to nth memory cells MC1 to MCn of each cell string are coupled between the source select transistor SST and the drain select transistor DST.

The first to nth memory cells MC1 to MCn may be divided into first to pth memory cells MC1 to MCp and a (p+1)th to nth memory cells MCp+1 to MCn. The first to pth memory cells MC1 to MCp are sequentially arranged in a −Z direction, and are coupled in series between the source select transistor SST and the pipe transistor PT. The (p+1)th to nth memory cells MCp+1 to MCn are sequentially arranged in the +Z direction, and are coupled in series between the pipe transistor PT and the drain select transistor DST. The first to pth memory cells MC1 to MCp and the (p+1)th to nth memory cells MCp+1 to MCn are coupled through the pipe transistor PT. Gate electrodes of the first to nth memory cells MC1 to MCn of each cell string are coupled to first to nth word lines WL1 to WLn, respectively.

A gate of the pipe transistor PT of each cell string is coupled to a pipe line PL.

The drain select transistor DST of each cell string is coupled between a corresponding bit line and the memory cells MCp+1 to MCn. Cell strings arranged in the row direction are coupled to a drain select line extending in the row direction. The drain select transistors of the cell strings CS11 to CS1m on the first row are coupled to a first drain select line DSL1. The drain select transistors of the cell strings CS21 to CS2m on the second row are coupled to a second drain select line DSL2.

Cell strings arranged in the column direction are coupled to a bit line extending in the column direction. In FIG. 4, the cell strings CS11 and CS21 on a first column are coupled to a first bit line BL1. The cell strings CS1m and CS2m on an mth column are coupled to an mth bit line BLm.

Memory cells coupled to the same word line in the cell strings arranged in the row direction constitute one page. For example, memory cells coupled to the first word line WL1 in the cell strings CS11 to CS1m on the first row constitute one page. Memory cells coupled to the first word line WL1 in the cell strings CS21 to CS2m on the second row constitute another page. As any one of the drain select lines DSL1 and DSL2 is selected, cell strings arranged in one row direction may be selected. As any one of the word lines WL1 to WLn is selected, one page may be selected in the selected cell strings.

In another embodiment, even bit lines and odd bit lines may be provided instead of the first to mth bit lines BL1 to BLm. In addition, even-numbered cell strings among the cell strings CS11 to CS1m or CS21 to CS2m arranged in the row direction may be coupled to the even bit lines, respectively, and odd-numbered cell strings among the cell strings CS11 to CS1m or CS21 to CS2m arranged in the row direction may be coupled to is the odd bit lines, respectively.

In an embodiment, at least one of the first to nth memory cells MC1 to MCn may be used as a dummy memory cell. For example, the dummy memory cell(s) may be provided to decrease an electric field between the source select transistor SST and the memory cells MC1 to MCp. Alternatively, the dummy memory cell(s) may be provided to decrease an electric field between the drain select transistor DST and the memory cells MCp+1 to MCn. When the number of dummy memory cells increases, the reliability of an operation of the memory block BLKa is improved. On the other hand, the size of the memory block BLKa increases. When the number of dummy memory cells decreases, the size of the memory block BLKa decreases. On the other hand, the reliability of an operation of the memory block BLKa may be deteriorated.

In order to efficiently control the dummy memory cell(s), each of the dummy memory cells may have a required threshold voltage. Before or after an erase operation of the memory block BLKa, a program operation may be performed on all or some of the dummy memory cells. When an erase operation is performed after the program operation is performed, the threshold voltage of the dummy memory cells control a voltage applied to the dummy word lines coupled to the respective dummy memory cells, so that the dummy memory cells can have the required threshold voltage.

FIG. 5 is a circuit diagram illustrating another example of a memory block BLKb, among the memory blocks BLK1 to BLKz, shown in FIG. 3.

Referring to FIG. 5, the memory block BLKb may include a plurality of cell strings CS11′ to CS1m′ and CS21′ to CS2m′. Each of the plurality of cell strings CS11′ to CS1m′ and CS21′ to CS2m′ extends along the +Z direction. Each of the plurality of cell strings CS11′ to CS1m′ and CS21′ to CS2m′ includes at least one source select transistor SST, first to nth memory cells MCI to MCn, and at least one drain select transistor DST, which are stacked on a substrate (not shown) under the memory block BLKb.

The source select transistor SST of each cell string is coupled between a common source line CSL and the memory cells MC1 to MCn. The source select transistors of cell strings arranged on the same row are coupled to the same source select line. The source select transistors of the cell strings CS11′ to CS1m′ arranged on a first row are coupled to a first source select line SSL1. Source select transistors of the cell strings CS21′ to CS2m′ arranged on a second row are coupled to a second source select line SSL2. In another embodiment, the source select transistors of the cell strings CS11′ to CS1m′ and CS21′ to CS2m′ may be commonly coupled to one source select line.

The first to nth memory cells MC1 to MCn of each cell string are coupled in series between the source select transistor SST and the drain select transistor DST. Gate electrodes of the first to nth memory cells MC1 to MCn are coupled to first to nth word lines WL1 to WLn, respectively.

The drain select transistor DST of each cell string is coupled between a corresponding bit line and the memory cells MC1 to MCn. The drain select transistors of cell strings arranged in the row direction are coupled to a drain select line extending in the row direction. The drain select transistors of the cell strings CS11′ to CS1m′ on the first row are coupled to a first drain select line DSL1. The drain select transistors of the cell strings CS21′ to CS2m′ on the second row are coupled to a second drain select line DSL2.

Consequently, the memory block BLKb of FIG. 5 has a circuit similar to that of the memory block BLKa of FIG. 4, except that the pipe transistor PT is excluded from each cell string in FIG. 5.

In another embodiment, even bit lines and odd bit lines may be provided instead of the first to mth bit lines BL1 to BLm. In addition, even-numbered cell strings among the cell strings CS11′ to CS1m′ or CS21′ to CS2m′ arranged in the row direction may be coupled to the even bit lines, respectively, and odd-numbered cell strings among the cell strings CS11′ to CS1m′ or CS21′ to CS2m′ arranged in the row direction may be coupled to the odd bit lines, respectively.

In an embodiment, at least one of the first to nth memory cells MC1 to MCn may be used as a dummy memory cell. For example, the dummy memory cell(s) may be provided to decrease an electric field between the source select transistor SST and the memory cells MC1 to MCp. Alternatively, the dummy memory cell(s) may be provided to decrease an electric field between the drain select transistor DST and the memory cells MCp+1 to MCn. When the number of dummy memory cells increases, the reliability of an operation of the memory block BLKb is improved. On the other hand, the size of the memory block BLKb is increased. When the number of dummy memory cells decreases, the size of the memory block BLKb decreases. On the other hand, the reliability of an operation of the memory block BLKb may be deteriorated.

In order to efficiently control the dummy memory cell(s), each of the dummy memory cells may have a required threshold voltage. Before or after an erase operation of the memory block BLKb, a program operation may be performed on all or some of the dummy memory cells. When an erase operation is performed after the program operation is performed, the threshold voltage of the dummy memory cells control a voltage applied to the dummy word lines coupled to the respective dummy memory cells, so that the dummy memory cells can have the required threshold voltage.

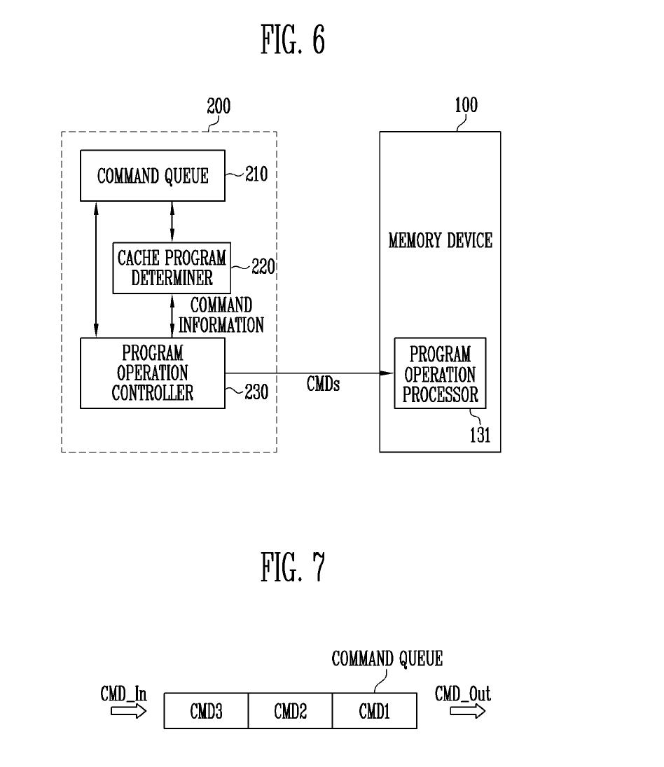

FIG. 6 is a diagram illustrating an operation of a memory device and a memory controller, e.g., the memory device 100 and the memory controller 200 of FIG. 1, according to an embodiment of the present disclosure.

Referring to FIG. 6, the memory device 100 may include a program operation processor 131. The memory controller 200 may include a command queue 210, a cache program determiner 220, and a program operation controller 230.

The program operation processor 131 may perform a program operation of storing data received from the program operation controller 230 in the memory device 100, in response to a program initiation command provided by the program operation controller 230. The program initiation command may instruct the program operation processor 131 to perform the program operation.

The program operation processor 131 may perform a normal program operation or cache program operation according to a program type command provided by the program operation controller 230. The program type command may represent whether a program operation to be performed by the program operation processor 131 in response to the program initiation command is the normal program operation or cache program operation.

In an embodiment, when the program operation to be performed is the normal program operation, the program type command may indicate a first type. When the program operation to be performed is the cache program operation, the program type command may indicate a second type.

When the received program type command indicates the first type, the program operation processor 131 may perform the normal program operation according to the program initiation command. When the program operation processor 131 performs the normal program operation, the program operation processor 131 may receive new data DATA to be stored in the memory device 100 from the program operation controller 230 after the program operation is completed.

When the received program type command indicates the second type, the program operation processor 131 may perform the cache program operation according to the program initiation command. When the program operation processor 131 performs the cache program operation, the program operation processor 131 may receive new data DATA to be stored in the memory device 100 from the program operation controller 230 while the program operation is being performed.

The command queue 210 may sequentially store a plurality of commands to be executed by the memory device 100. The stored command may be any one of a read command, a program command, and an erase command. The command may be generated according to a request of the host 300. The commands stored in the command queue 210 may be performed by the memory device 100 in the sequence in which they are generated. That is, the commands stored in the command queue 210 may be managed using a first-in first-out (FIFO) scheme.

The cache program determiner 220 may determine whether a command to be executed next to a program command provided to the program operation processor 131, among consecutive commands sequentially stored in the command queue 210, is a program command. The cache program determiner 220 may generate command information representing whether such command to be executed next is a program command. The cache program determiner 220 may provide the generated command information to the program operation controller 230.

The program operation controller 230 may determine whether a command stored in the command queue 210 is a program command. When the stored command is a program command, the program operation controller 230 may provide the program operation processor 131 with a program initiation command according to the program command. The program operation controller 230 may provide the program operation processor 131 with a program type command corresponding to the program initiation command.

The program initiation command may instruct the program operation processor 131 to perform a program operation of storing data. The program type command may represent whether a program operation to be performed by the program operation processor 131 is a normal program operation or cache program operation.

In an embodiment, when the program operation to be performed by the program operation processor 131 is the normal program operation, the program type command may indicate a first type. When the program operation to be performed by the program operation processor 131 is the cache program operation, the program type command may indicate a second type.

The program operation controller 230 may sequentially provide the program operation processor 131 with the program initiation command, an address of the memory device 100, at which data is to be stored, the data, and the program type command. In another embodiment, the sequence in which the program initiation command and the data are provided to the program operation processor 131 may be reversed.

For example, when a first command among consecutive first and second commands sequentially stored in the command queue 210 is a program command, the program operation controller 230 may provide the program initiation command to the program operation processor 131 according to the first program command. The second command may be executed next to the first command by the memory device 100.

The program operation controller 230 may receive, from the cache program determiner 220, command information representing whether the second command is a program command. When the second command is the program command according to the command information, the program operation controller 230 may control the program operation processor 131 to perform the cache program operation. When the second command is a read command or erase command according to the command information, the program operation controller 230 may control the program operation processor 131 to perform the normal program operation.

The program operation controller 230 may determine a program type command corresponding to the program initiation command according to the command information.

For example, when the second command is the read command or erase command according to the command information, the program operation controller 230 may determine the program type command to indicate the first type. When the second command is the program command according to the command information, the program operation controller 230 may determine the program type command to indicate the second type. The program operation controller 230 may provide the determined program type command to the program operation processor 131. The program operation processor 131 may perform a program operation according to the first command as the normal program operation or cache program operation according to the program type command provided thereto.

In an embodiment, when the program type command indicates the first type, the program operation processor 131 may perform the normal program operation according to the first command. Therefore, after the program operation processor 131 completes the normal program operation according to the first command, the program operation controller 230 may provide the program operation processor 131 with data to be stored according to another program command.

When the program type command indicates the second type, the program operation processor 131 may perform the cache program operation according to the first command. Therefore, while the program operation processor 131 is performing the cache program operation according to the first command, the program operation controller 230 may provide the program operation processor 131 with data to be stored according to the second command.

FIG. 7 is a diagram illustrating the command queue shown in FIG. 6.

Referring to FIG. 7, the command queue may sequentially store commands to be executed by the memory device 100 described with reference to FIG. 1. In an embodiment, the command queue may store first to third commands CMD1 to CMD3. However, the number of commands stored in the command queue is not limited to three. Each of the first to third commands CMD1 to CMD3 may be any one of a read command, an erase command, and a program command.

The commands stored in the command queue may be managed using a first-in first-out (FIFO) scheme. Therefore, the commands input and stored in the command queue may be output from the command queue in the sequence in which they are input. For example, the first command CMD1, the second command CMD2 and the third command CMD3 may be input in that order and output in that same order.

In an embodiment, the first command CMD1 may be a program command. A program initiation command may be provided to the memory device 100 according to the first command CMD1. A program type command corresponding to the program initiation command may be provided to the memory device 100.

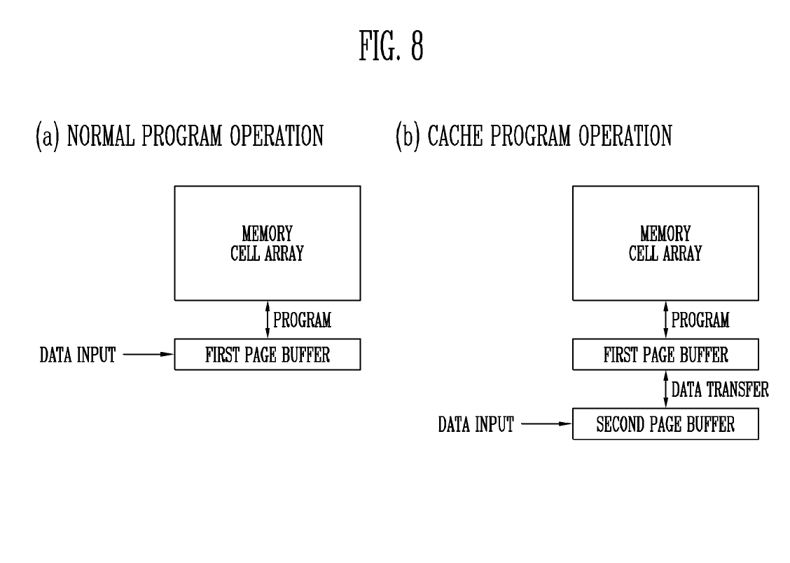

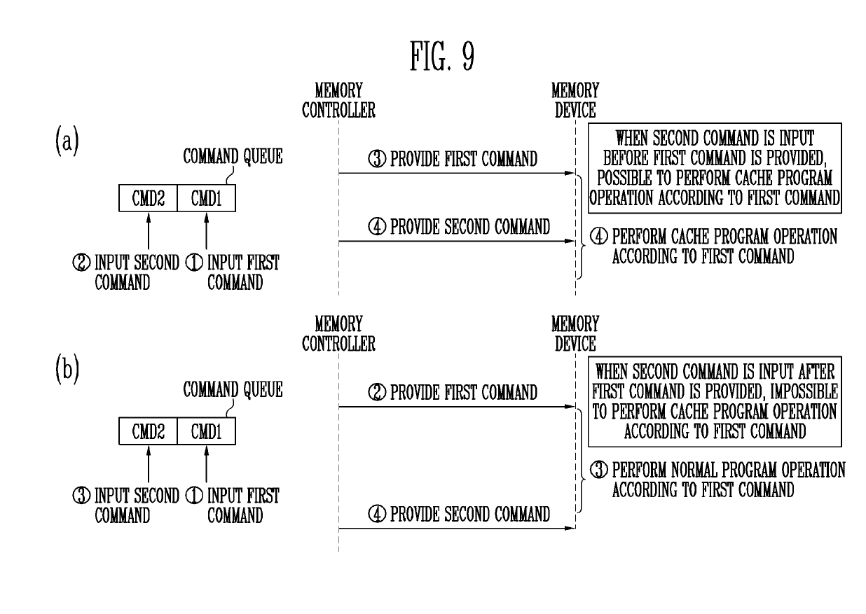

FIG. 8 is a diagram illustrating a normalprogram operation and a cache program operation.

Referring to FIG. 8, a first page buffer and a second page buffer may among the plurality of page buffers PBs included in the read/write circuit 123 described with reference to FIG. 2. Each of the first page buffer and the second page buffer may be configured as multiple buffers. The memory cell array may include a plurality of memory cells. In FIG. 8, both a first command and a second command may be program commands.

Portion (a) of FIG. 8 illustrates a normal program operation according to an embodiment.

Referring to (a) of FIG. 8, program data to be stored according to the first command may be input and stored in the first page buffer. A program operation of storing, in the memory cell array, the program data stored in the first page buffer may be performed. The first page buffer may store program data, which is newly received after the program operation is completed. Therefore, when the normal program operation is performed, program data to be stored according to the second command may be input and stored in the first page buffer after the program operation according to the first command is completed.

Portion (b) of FIG. 8 illustrates a cache program operation according to an embodiment.

Referring to (b) of FIG. 8, unlike the normal program operation shown in the (a), program data to be stored according to the second command may be input and stored in the second page buffer while the program operation according to the first command is being performed. The second page buffer may be a cache page buffer used in the cache program operation. When the program operation of storing, in the memory cell array, the program data to be stored according to the first command, which is stored in the first page buffer, is completed, the program data to be stored according to the second command stored in the second page buffer may be transferred to the first page buffer.

In the normal program operation, next program data may be input after a program operation of storing data is completed. In the cache program operation, next program data may be input while the program operation is being performed. Thus, as compared with the normal program operation, in the cache program operation, the entire program time may be reduced by at least partially overlapping a time at which next program data is input and a program operation time. That is, when a program operation on write data is performed, the cache program operation may have data write performance higher than that of the normal program operation.

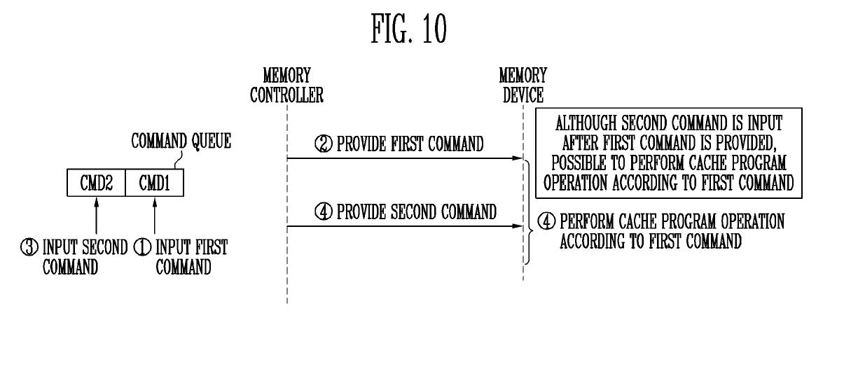

FIG. 9 is a diagram illustrating a program operation according to an embodiment of the present disclosure. The program operation may be performed in the memory device 100, by the memory controller 200 of FIGS. 1 and 6.

Referring to FIG. 9, in (a), a first command and a second command may be program commands. After the first command and the second command are sequentially input to a command queue (\textcircled{1}, \textcircled{2}), the first command may be provided to the memory device (\textcircled{3}).

Since the first command and the second command, which are consecutive program commands are input in the command queue, a memory controller may set the first command as a cache program command and provide the first (cache program) command to the memory device. The memory controller may provide the second command to the memory device (\textcircled{4}) while a cache program operation according to the first command is being performed (\textcircled{4}). The memory controller may provide the memory device with data to be stored according to the second command while the cache program operation is being performed.

In (b), a first command and a second command may be program commands. The first command may be provided to the memory device (\textcircled{2}) after the first command is input to the command queue (\textcircled{1}).

Since only the first command is input to the command queue, the memory controller may set the first command as a normal program command and provide the first (normal) command to the memory device (\textcircled{2}). The second command may be input to the command queue (\textcircled{3}) after the first command is provided to the memory device (\textcircled{2}). Therefore, after the first command is provided to the memory device, the memory controller cannot control a program operation according to the first command to be performed as a cache program operation.

While a normal program operation according to the first command is being performed (\textcircled{3}), the memory controller cannot provide the second command to the memory device. That is,the memory controller may provide the second command to the memory device (\textcircled{4}) after the normal program operation is completed. The memory controller may provide the memory device with data to be stored according to the second command after the normal program operation is completed.

FIG. 10 is a diagram illustrating a program operation according to another embodiment of the present disclosure. The program operation may be performed in the memory device 100, by the memory controller 200 of FIGS. 1 and 6.

Referring to FIG. 10, a first command may be a program command. The first command may be provided to the memory device (\textcircled{2}) after the first command is input to a command queue (\textcircled{1}).

Since the first command is input to the command queue, a memory controller may provide the memory device with a program initiation command corresponding to the first command. The program initiation command may indicate a program operation of storing data. The memory controller may provide the memory device with data to be stored according to the first command after the program initiation command is provided.

After the data to be stored according to the first command is provided to the memory device (\textcircled{2}), the memory controller may provide the memory device with a program type command corresponding to the first command. When the program operation indicated by the program initiation command is a normal program operation, the program type command may indicate a first type. When the program operation indicated by the program initiation command is a cache program operation, the program type command may indicate a second type.

In an embodiment, a second command may be input to the command queue (\textcircled{3}) after the program initiation command corresponding to the first command is provided to the memory device (\textcircled{2}). The second command may be a program command to be executed next to the first command by the memory device. The memory controller may determine a program type command corresponding to the first command depending on whether the second command is a program command.

Therefore, although the second command is input after the program initiation command corresponding to the first command is input, the memory controller may control the memory device to perform the program operation according to the first command as the cache program operation (\textcircled{4}).

Specifically, when the second command is input to the command queue (\textcircled{3}) before the program type command corresponding to the first command is provided to the memory device, the memory controller may set the program type command corresponding to the first command to indicate the second type. Since the received program type command indicates the second type, the memory device may perform the cache program operation (\textcircled{4}).

While the cache program operation according to the first command is being performed (\textcircled{4}), the memory controller may provide the memory device with a program initiation command corresponding to the second command, data to be stored according to the second command, and a program type command corresponding to the second command. The memory controller may provide the memory device with the data to be stored according to the second command while the cache program operation is being performed.

According to the embodiment shown in FIG. 10, even after program data to be stored according to the first command is provided to the memory device, the program operation according to the first command may be performed as the normal program operation or cache program operation depending on whether the second command is a program command.

Thus, in the embodiment shown in FIG. 10, a delay occurring in the setting of the cache program command may be reduced, as compared with the embodiment shown in FIG. 9, in which the memory controller is to provide the first command to the memory device after the memory controller waits until the first and second commands are input to the command queue so as to perform the cache program operation.

Further, the program operation to be performed as the normal program operation according to the embodiment shown in FIG. 9 is performed as the cache program operation, so that the entire program time on consecutive write data may be reduced.

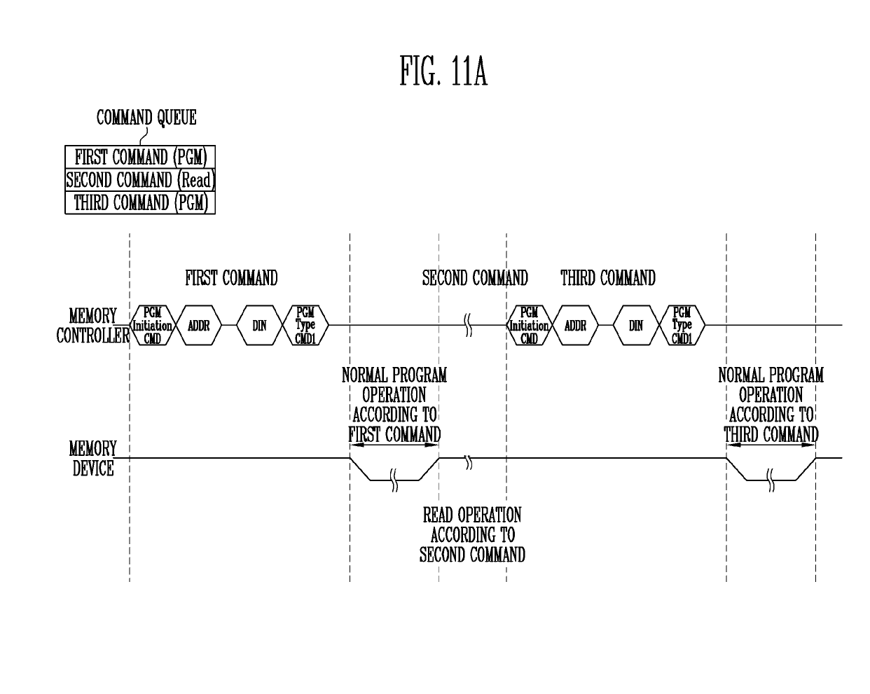

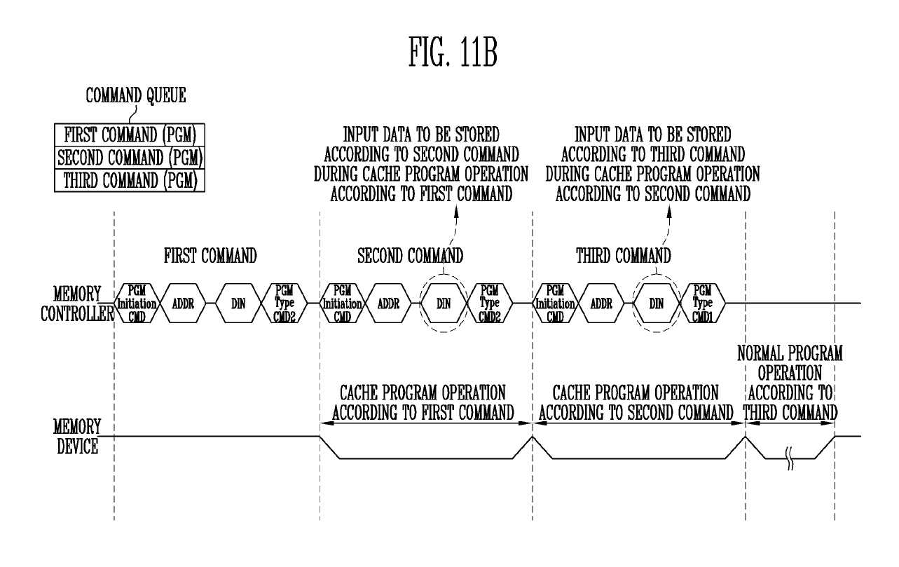

FIG. 11A is a diagram illustrating the normal program operation shown in FIG. 10. The normal program operation may be performed in the memory device 100, by the memory controller 200 of FIGS. 1 and 6.

Referring to FIG. 11A, the command queue may sequentially store first to third commands to be executed by the memory device. The first and third commands may be program commands (PGM). The second command may be a read command.

The memory controller may sequentially provide the memory device with a program initiation command (PGM Initiation CMD), an address (ADDR), data (DIN), and a program type command (PGM Type CMD) according to the first command stored in the command queue. The program initiation command (PGM Initiation CMD) may indicate a program operation of storing data. When the program operation indicated by the program initiation command is a normal program operation, the program type command (PGM Type CMD) may indicate a first type (PGM Type CMD1). When the program operation indicated by the program initiation command is a cache program operation, the program type command (PGM Type CMD) may indicate a second type (PGM Type CMD2).

Since the second command to be executed next to the first command is the read command instead of the program command, the memory controller may determine the program type command corresponding to the first command to indicate the first type.

When the memory device receives the program type command corresponding to the first command, the memory device may perform a program operation on data to be stored according to the first command. Since the program type command indicates the first type, the memory device may perform the normal program operation.

While the normal program operation according to the first command is being performed, the memory controller cannot provide the second command to the memory device. After the normal program operation according to the first command is completed, the memory controller may provide the second command to the memory device.

The memory device may perform a read operation in response to the second command that is the read command.

When the read operation according to the second command is completed, the memory controller may control the memory device to perform a program operation according to the third command PGM in the same manner as described above.

FIG. 11B is a diagram illustrating the cache program operation shown in FIG. 10. The cache program operation may be performed in the memory device 100, by the memory controller 200 of FIGS. 1 and 6.

Referring to FIG. 11B, the command queue may sequentially store first to third commands to be executed by the memory device. The first to third commands may be program commands (PGM), as compared with FIG. 11A.

The memory controller may sequentially provide the memory device with a program initiation command (PGM Initiation CMD), an address (ADDR), data (DIN), and a program type command (PGM Type CMD1) according to the first command stored in the command queue.

Since the second command to be executed next to the first command is a program command, the memory controller may determine a program type command (PGM Type CMD2) corresponding to the first command to indicate a second type. Since the received program type command indicates the second type, the memory device may perform a program operation according to the first command as a cache program operation.

While the cache program operation according to the first command is being performed, the memory controller may provide the second command to the memory device.

Specifically, the memory controller may provide a program initiation command, an address, data, and a program type command (PGM Type CMD2) according to the second command while the program operation according to the first command is being performed. The data may be data to be stored according to the second command.

In the same manner, since the third command to be executed next to the second command is a program command, the memory controller may determine a program type command (PGM Type CMD2) corresponding to the second command to indicate the second type. Since the received program type command indicates the second type, the memory device may perform a program operation according to the second command as the cache program operation.

While the program operation according to the second command is being performed, the memory controller may provide the third command to the memory device. The memory controller may provide a program initiation command, an address, data, and a program type command according to the third command while the cache program operation according to the second command is being performed. The data may be data to be stored according to the third command.

When a new command is not input to the command queue after the third command is input or when an input command is not a program command (that is, when the input command is a read command or erase command), the memory controller may determine a program type command (PGM Type CMD1) corresponding to the third command to indicate a first type.

Since the program type command (PGM Type CMD1) corresponding to the third command indicates the first type, the memory device may perform a program operation according to the third command as a normal program operation. Therefore, after the normal program operation is completed, the memory controller may provide a newly input command to the memory device.

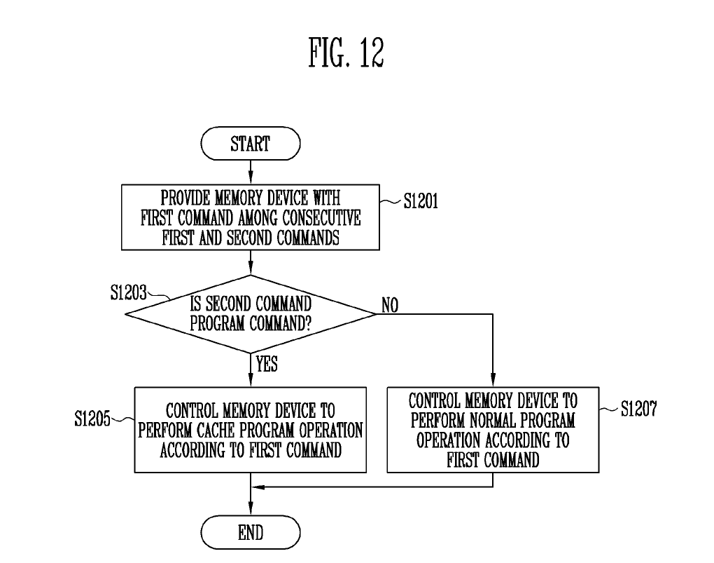

FIG. 12 is a flowchart illustrating an operation of a memory controller, e.g., memory controller 200 of FIGS. 1 and 6, according to an embodiment of the present disclosure.

Referring to FIG. 12, at step S1201, the memory controller may provide a memory device, e.g., the memory device 100 of FIGS. 1 and 6, with a first command among consecutive first and second commands. The first command may be a program command. The second command may be executed next to the first command by the memory device.

At step S1203, the memory controller may determine whether the second command is a program command. When the second command is determined to be the program command (that is, “YES” at step S1203), the memory controller proceeds to step S1205. When the second command is not the program command as determined at step S1203 (that is, “NO” at step S1203), the memory controller proceeds to step S1207.

At the step S1205, even after the memory controller provides data stored according to the first command, the memory controller may control the memory device to perform a program operation according to the first command as a cache program operation. Therefore, while the memory device is performing the program operation according to the first command, the memory controller may provide the memory device with data to be stored according to the second command.

At the step S1207, even after the memory controller provides the data to be stored according to the first command, the memory controller may control the memory device to perform the program operation according to the first command as a normal program operation. Therefore, after the program operation according to the first command is completed, the memory controller may provide the second command to the memory device.

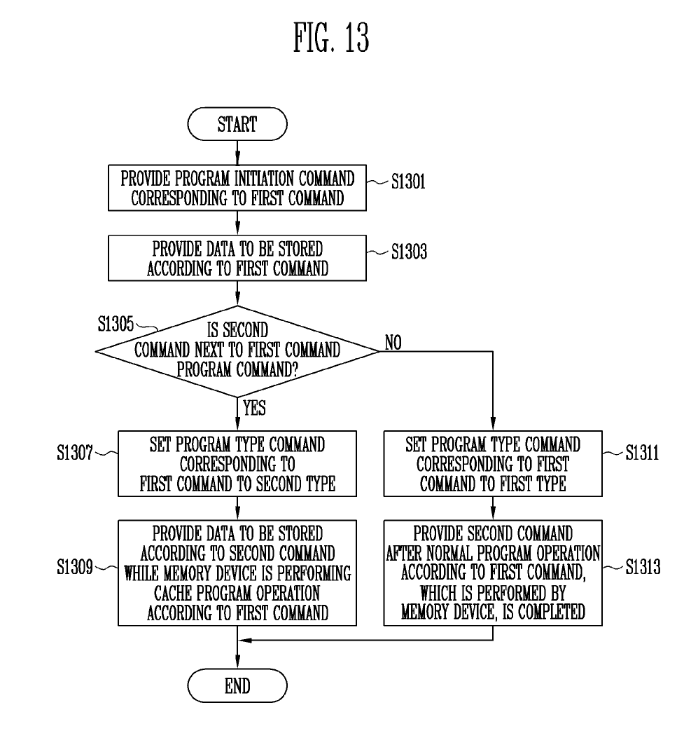

FIG. 13 is a flowchart illustrating in detail the operation of the memory controller, which is shown in FIG. 12, The operation of FIG. 13 may be performed for the memory device 100 by the memory controller 200 of FIGS. 1 and 6.

Referring to FIG. 13, at step S1301, the memory controller may provide the memory device with a program initiation command corresponding to a first command. The first command may be a program command.

At step S1303, the memory controller may provide the memory device with data to be stored according to the first command.

At step S1305, the memory controller may determine whether a second command next to the first command is a program command. The second command may be executed next to the first command by the memory device. When it is determined that the second command next to the first command is the program command (that is, “YES” at step S1305), the memory controller proceeds to step S1307. When it is determined that the second command next to the first command is not the program command (e.g., when it is determined that the second command is a read or erase command) (that is, “NO” at step S1305), the memory controller proceeds to S1311.

At the step S1307, the memory controller may set a program type command corresponding to the first command to a second type, and provide the set program type command to the memory device. When a program operation indicated by the program initiation command is a normal program operation, the program type command may indicate a first type. When the program operation indicated by the program initiation command is a cache program operation, the program type command may indicate the second type.

At step S1309, while the memory device is performing the cache program operation according to the first command, the memory controller may provide data according to the second command.

At the step S1311, the memory controller may set the program type command corresponding to the first command to the first type, and provide the set program type command to the memory device.

At step S1313, when the normal program operation according to the first command, which is performed by the memory device, is completed, the memory controller may provide the second command to the memory device.

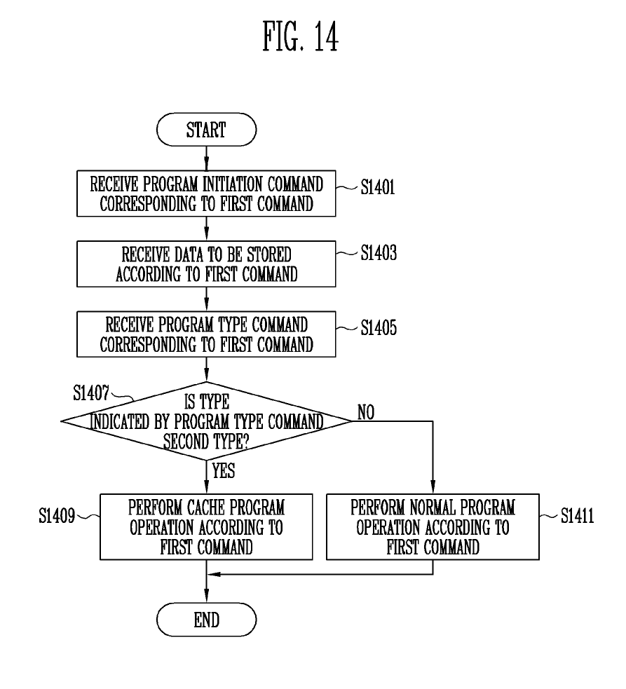

FIG. 14 is a flowchart illustrating an operation of the memory device according to an embodiment of the present disclosure. The operation of FIG. 14 may be performed by the memory device 100 of FIGS. 1 and 6.

Referring to FIG. 14, at step S1401, the memory device may receive, from a memory controller, e.g., the memory controller 200 of FIGS. 1 and 6, a program initiation command corresponding to a first command that is a program command. The program initiation command may indicate a program operation.

At step S1403, the memory device may receive data to be stored according to the first command from the memory controller.

At step S1405, the memory device may receive a program type command corresponding to the first command from the memory controller. When the program operation according to the program initiation command is a normal program operation, the program type command may indicate a first type. When the program operation according to the program initiation command is a cache program operation, the program type command may indicate a second type.

At step S1407, the memory device may determine whether the type indicated by the program type command is the second type. When it is determined that the type indicated by the program type command is the second type (that is, “YES” at step S1407), the memory device proceeds to step S1409. When it is determined that the type indicated by the program type command is not the second type (that is, “NO” at step S1407), the memory device proceeds to step S1411.

At the step S1409, the memory device may perform the cache program operation. Therefore, while the memory device is performing a program operation of storing data to be stored according to the first command, the memory device may receive data to be stored according to a second command from the memory controller. The second command may be executed next to the first command by the memory device.

At the step S1411, the memory device may perform the normal program operation. Therefore, while the memory device is performing the program operation of storing the data to be stored according to the first command, the memory device may not receive, from the memory controller, data to be stored according to the program command to be executed next to the first command.

That is, after the program operation of storing the data to be stored according to the first command is completed, the memory device may receive, from the memory controller, data to be stored according to the program command to be executed next to the first command.

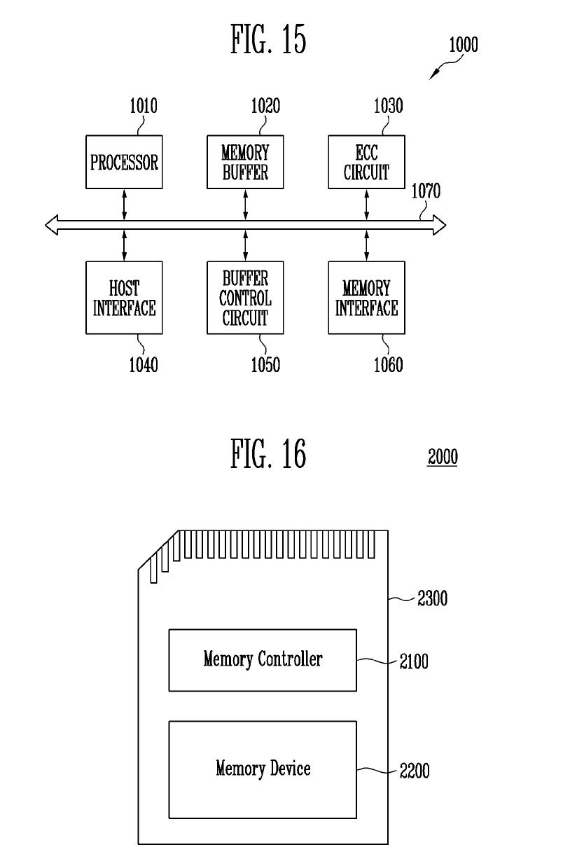

FIG. 15 is a diagram illustrating another embodiment of a memory controller, such as that shown in FIG. 1.

Referring to FIG. 15, the memory controller 1000 is coupled to a host (e.g., host 300 of FIG. 1) and a memory device (e.g., memory device 100 of FIG. 1). The memory controller 1000 is configured to access the memory device in response to a request received from the host. For example, the memory controller 1000 is configured to control read, program, erase, and background operations of the memory device. The memory controller 1000 is configured to provide an interface between the memory device and the host. The memory controller 1000 is configured to drive firmware for controlling the memory device.

The memory controller 1000 may include a processor 1010, a memory buffer 1020, an error correction code (ECC) circuit 1030, a host interface 1040, a buffer control circuit 1050, a memory interface 1060, and a bus 1070.

The bus 1070 may be configured to provide channels between components of the memory controller 1000.

The processor 1010 may control overall operations of the memory controller 1000, and perform a logical operation. The processor 1010 may communicate with the host through the host interface 1040, and communicate with the memory device through the memory interface 1060. Also, the processor 1010 may communicate with the memory buffer 1020 through the buffer control circuit 1050. The processor 1010 may control an operation of the storage device, using the memory buffer 1020 as a working memory, a cache memory or a buffer memory.

The processor 1010 may perform a function of a flash translation layer (FTL). The processor 1010 may translate a logical block address (LBA) provided by the host through the FTL into a physical block address (PBA). The FTL may receive an LBA, using a mapping table, to be translated into a PBA. Several address mapping methods of the FTL exist according to mapping units. Representative address mapping methods include a page mapping method, a block mapping method, and a hybrid mapping method.

The processor 1010 is configured to randomize data received from the host. For example, the processor 1010 may randomize data received from the host, using a randomizing seed. The randomized data is provided as data to be stored to the memory device to be programmed in the memory cell array of the memory device.

In a read operation, the processor 1010 is configured to derandomize data received from the memory device. For example, the processor 1010 may derandomize data received from the memory device, using a derandomizing seed. The derandomized data may be output to the host.

In an embodiment, the processor 1010 may perform randomizing and derandomizing by driving software or firmware.

The memory buffer 1020 may be used as the working memory, the cache memory, or the buffer memory of the processor 1010. The memory buffer 1020 may store codes and commands, which are executed by the processor 1010. The memory buffer 1020 may include a static random access memory (RAM) (SRAM) or a dynamic RAM (DRAM).

The ECC circuit 1030 may perform an ECC operation. The ECC circuit 1030 may perform ECC encoding on data to be written in the memory device through the memory interface 1060. The ECC encoded data may be transferred to the memory device through the memory interface 1060. The ECC circuit 1030 may perform ECC decoding on data received from the memory device through the memory interface 1060. In an example, the ECC circuit 1030 may be included as a component of the memory interface 1060.

The host interface 1040 may communicate with the host under the control of the processor 1010. The host interface 1040 may communicate with the host using at least one of various communication protocols, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a nonvolatile memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

The buffer control circuit 1050 is configured to control the memory buffer 1020 under the control of the processor 1010.

The memory interface 1060 is configured to communicate with the memory device under the control of the processor 1010. The memory interface 1060 may communicate a command, an address, and data with the memory device through a channel.

In an example, the memory controller 1000 may not include the memory buffer 1020 and the buffer control circuit 1050. Either or both of these components may be provided separately, or either or both of their functions may be distributed within the memory controller 1000.

In an example, the processor 1010 may control an operation of the memory controller 1000 by using codes. The processor 1010 may load codes from a nonvolatile memory device (e.g., a read only memory (ROM)) provided in the memory controller 1000. In another example, the processor 1010 may load codes from the memory device through the memory interface 1060.

In an example, the bus 1070 of the memory controller 1000 may be divided into a control bus and a data bus. The data bus may be configured to transmit data in the memory controller 1000, and the control bus may be configured to transmit control information such as a command and an address in the memory controller 1000. The data bus and the control bus are separated from each other so as not to interfere with, or influence, each other. The data bus may be coupled to the host interface 1040, the buffer control circuit 1050, the ECC circuit 1030, and the memory interface 1060. The control bus may be coupled to the host interface 1040, the processor 1010, the buffer control circuit 1050, the memory buffer 1020, and the memory interface 1060.

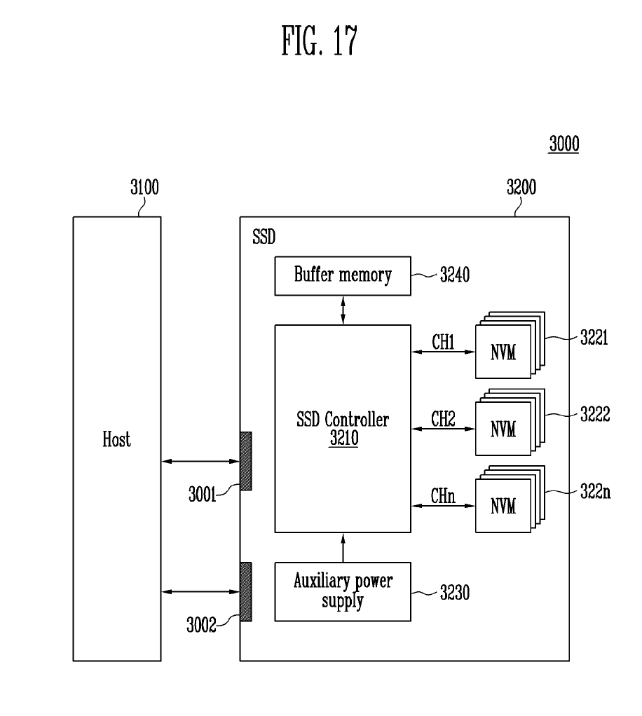

FIG. 16 is a block diagram illustrating a memory card system 2000 to which the storage device is applied according to an embodiment of the present disclosure.

Referring to FIG. 16, the memory card system 2000 includes a memory controller 2100, a memory device 2200, and a connector 2300.

The memory controller 2100 is coupled to the memory device 2200. The memory controller 2100 is configured to access the memory device 2200. For example, the memory controller 2100 is configured to control read, write, erase, and background operations of the memory device 2200. The memory controller 2100 is configured to provide an interface between the memory device 2200 and a host (e.g., host 300 of FIG. 1). The memory controller 2100 is configured to drive firmware for controlling the memory device 2200. The memory controller 2100 may be implemented identically to the memory controller 200 described with reference to FIG. 1.

In an example, the memory controller 2100 may include components such as a random access memory (RAM), a processor, a host interface, a memory interface, and an error correction code (ECC) circuit.

The memory controller 2100 may communicate with an external device through the connector 2300. The memory controller 2100 may communicate with the external device (e.g., the host 300 of FIG. 1) according to a specific communication protocol. In an example, the memory controller 2100 may communicate with the external device through at least one of various communication protocols such as a Universal Serial Bus (USB), Mufti-Media Card (MMC) an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), firewire, a Universal Flash Storage (UFS), wireless fidelity (Wi-Fi), Bluetooth, and NVMe.

In an example, the memory device 2200 may be implemented as any of various nonvolatile memory devices, such as an Electrically Erasable and Programmable ROM (EPROM), a NAND flash memory, a NOR flash memory, a Phase-change RAM (PRAM), a Resistive RAM (ReRAM), a Ferroelectric RAM (FRAM), and a Spin Torque Transfer magnetic RAM (STT-MRAM).

The memory controller 2100 and the memory device 2200 may be integrated into a single semiconductor device, to constitute a memory card, such as a PC card (e.g., a Personal Computer Memory Card International Association (PCMCIA) card), a Compact Flash (CF) card, a Smart Media Card (e.g., SM and SMC), a memory stick, a Multi-Media Card (e.g, MMC, RS-MMC, MMCmicro and eMMC), an SD card (e.g., SD, miniSD, microSD and SDHC), and/or a Universal Flash Storage (UFS).

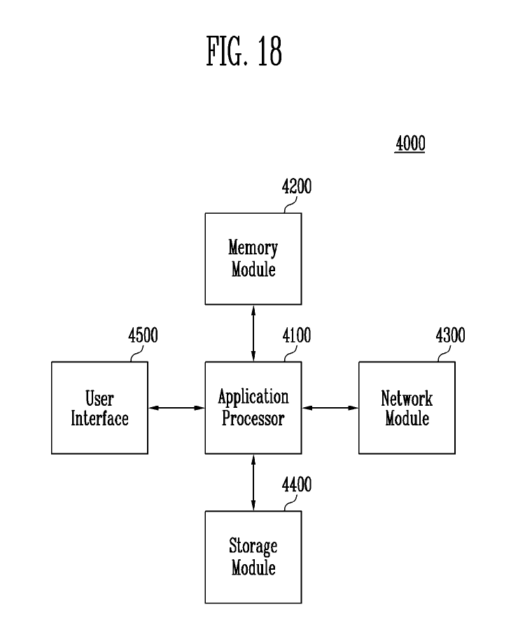

FIG. 17 is a block diagram illustrating a solid state drive (SSD) system 3000 to which the storage device is applied according to an embodiment of the present disclosure.

Referring to FIG. 17, the SSD system 3000 includes a host 3100 and an SSD 3200. The SSD 3200 exchanges a signal SIG with the host 3100 through a signal connector 3001, and receives power PWR through a power connector 3002. The SSD 3200 includes an SSD controller 3210, a plurality of nonvolatile memories (NVMs) (e.g., flash memories) 3221 to 322n, an auxiliary power supply 3230, and a buffer memory 3240.

In an embodiment, the SSD controller 3210 may serve as the memory controller 200 described with reference to FIG. 1.

The SSD controller 3210 may control the plurality of flash memories 3221 to 322n in response to a signal SIG received from the host 3100. In an example, the signal SIG may be a signal based on an interface between the host 3100 and the SSD 3200. For example, the signal SIG may be a signal defined by at least one of various interfaces, such as a Universal Serial Bus (USB), a Multi-Media Card (MMC) an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), a firewire, a Universal Flash Storage (UFS), a wireless fidelity (Wi-Fi), a Bluetooth, and a nonvolatile memory express (NVMe).

The auxiliary power supply 3230 is coupled to the host 3100 through the power connector 3002. When the supply of power from the host 3100 is not smooth, the auxiliary power supply 3230 may provide power of the SSD 3200. In an example, the auxiliary power supply 3230 may be disposed in the SSD 3200, or externally to the SSD 3200. For example, the auxiliary power supply 3230 may be located on a main board, and provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or temporarily store meta data (e.g., a mapping table) of the flash memories 3221 to 322n. The buffer memory 3240 may include any of a various volatile memories, such as a dynamic random access memory (RAM) (DRAM), a synchronous DRAM (SDRAM), a double data rate (DDR) SDRAM, a low-power DDR (LPDDR) SDRAM, and a graph RAM (GRAM) or nonvolatile memories such as a ferroelectric RAM (FRAM), a resistive RAM (ReRAM), an STT-MRAM, and a phase-change RAM (PRAM).

FIG. 18 is a block diagram illustrating a user system 4000 to which the storage device is applied according to an embodiment of the present disclosure.

Referring to FIG. 18, the user system 4000 includes an application processor 4100, a memory module 4200, a network module 4300, a storage module 4400, and a user interface 4500.

The application processor 4100 may drive components included in the user system 4000, an operating system (OS), a user program, or the like. In an example, the application processor 4100 may include controllers for controlling components included in the user system 4000, interfaces, a graphic engine, and the like. The application processor 4100 may be provided as a System-on-Chip (SoC).

The memory module 4200 may operate as a main memory, working memory, buffer memory or cache memory of the user system 4000. The memory module 4200 may include any of various nonvolatile random access memories, such as a dynamic random access memory (RAM) (DRAM), a synchronous DRAM (SDRAM), a double data rate (DDR) SDRAM, a DDR2 SDRM, a DDR3 SDRAM, an LPDDR SDRAM, a low-power DDR2 (LPDDR2) SDRAM, and an LPDDR3 SDRAM or volatile random access memories such as a phase-change RAM (PRAM), a resistive RAM (ReRAM), a magnetic RMA (MRAM), and a ferroelectric RAM (FRAM). In an example, the application processor 4100 and the memory module 4200 may be provided as one semiconductor package packaged based on a Package on Package (PoP).

The network module 4300 may communicate with external devices. In an example, the network module 4300 may support wireless communications such as Code Division Multiple Access (CDMA), Global System for Mobile communication (GSM), Wideband CDMA (WCDMA), CDMA-2000, Time Division Multiple Access (TDMA), Long Term Evolution (LTE), Wimax, wireless local area network (WLAN), ultra-wideband (UWB), Bluetooth, and wireless fidelity (Wi-Fi). In an example, the network module 4300 may be included in the application processor 4100.

The storage module 4400 may store data. For example, the storage module 4400 may store data received from the application processor 4100. Alternatively, the storage module 4400 may transmit data stored therein to the application processor 4100. In an example, the storage module 4400 may be implemented with a nonvolatile semiconductor memory device such as a phase-change RAM (PRAM), a magnetic RAM (MRAM), a resistive RAM (RRAM), a NAND flash, a NOR flash, or a NAND flash having a three-dimensional structure. In an example, the storage module 4400 may be provided as a removable drive such as a memory card of the user system 4000 or an external drive.

In an example, the storage module 4400 may include a plurality of nonvolatile memory devices, and the plurality of nonvolatile memory devices may operate identically to the memory device described with reference to FIG. 1. The storage module 4400 may operate identically to the storage device 50 described with reference to FIG. 1.

The user interface 4500 may include interfaces for inputting data or commands to the application processor 4100 or outputting data to an external device. In an example, the user interface 4500 may include user input interfaces such as a keyboard, a keypad, a button, a touch panel, a touch screen, a touch pad, a touch ball, a camera, a microphone, a gyroscope sensor, a vibration sensor and a piezoelectric element. The user interface 4500 may include user output interfaces such as a Liquid Crystal Display (LCD), an Organic Light Emitting Diode (OLED) display device, an Active Matrix OLED (AMOLED) display device, an LED, a speaker, and a motor.

According to embodiments of the present disclosure, a storage device having improved cache program operation performance and an operating method thereof are provided.

In the above-described embodiments, steps may be selectively performed or part of the steps and may be omitted. In each embodiment, the steps are not necessarily performed in accordance with the described order and may be rearranged. The embodiments disclosed herein are intended to facilitate an understanding of the present invention, not to limit it. That is, it should be apparent to those skilled in the art that various modifications can be made on the basis of the present disclosure.

Various embodiments of the present disclosure have been illustrated and described. In some cases, specific terminologies are used to explain the embodiments of the present disclosure. However, the present invention is not restricted to the above-described embodiments or limited by specific terminology. As those skilled in the art will recognize in light of the present disclosure many variations and modifications may be made without departing from the spirit and scope of the present disclosure.

The present invention encompasses all such variations and modifications to the extent they fall within the scope of the claims and equivalents thereof.

What is claimed is:

1. A memory controller for controlling a memory device, the memory controller comprising:
a command queue configured to sequentially store commands to be executed by the memory device;
a cache program determiner configured to determine, when a first command that is a program command stored in the command queue is provided to the memory device, whether a second command to be executed next in time to the first command is a program command; and
a program operation controller configured to control the memory device to perform a program operation according to the first command as one of a normal program operation and a cache program operation, depending on whether the second command is a program command.

2. The memory controller of claim 1, wherein the cache program determiner generates command information representing whether the second command is a program command, and
wherein the program operation controller provides the memory device with a program initiation command indicating initiation of a program operation corresponding to the first command, determines a program type command corresponding to the first command according to the command information, and provides the determined program type command to the memory device.

3. The memory controller of claim 2, wherein the program type command indicates one of a first type indicating that the program operation is the normal program operation and a second type indicating that the program operation is the cache program operation.

4. The memory controller of claim 3, wherein the program operation controller sequentially provides the memory device with the program initiation command, an address of the memory device, at which data to be stored according to the first command is to be stored, the data to be stored according to the first command, and the program type command.

5. The memory controller of claim 3, wherein, when the second command is a read command or erase command, the program operation controller determines the program type command corresponding to the first command to indicate the first type.

6. The memory controller of claim 5, wherein, after the program operation according to the first command is completed, the program operation controller provides the second command to the memory device.

7. The memory controller of claim 3, wherein, when the second command is a program command, the program operation controller determines the program type command corresponding to the first command to indicate the second type.

8. The memory controller of claim 7, wherein, while the program operation according to the first command is being performed, the program operation controller provides the memory device with data to be stored according to the second command.

9. A method for operating a memory controller that controls a memory device and includes a command queue for sequentially storing commands to be executed by the memory device, the method comprising:
providing the memory device with a program initiation command indicating initiation of a program operation corresponding to a first command that is a program command stored in the command queue; and
controlling the memory device to perform a program operation according to the first command as one of a normal program operation and a cache program operation depending on whether a second command to be executed next in time to the first command is a program command.

10. The method of claim 9, wherein the controlling of the memory device further includes:
determining a program type command corresponding to the first command, depending on whether the second command is a program command; and
providing the memory device with the program type command corresponding to the first command,
wherein the program type command is a command indicating one of a first type indicating that the program operation is the normal program operation and a second type indicating that the program operation is the cache program operation.

11. The method of claim 10, wherein the determining of he program type command includes:
determining the program type command to indicate the first type, when the second command is a read command or erase command; and
determining the program type command to indicate the second type, when the second command is a program command.

12. The method of claim 11, further comprising providing the second command to the memory device after the program operation according to the first command is completed, when the program type command indicates the first type.

13. The method of claim 11, further comprising providing the memory device with data to he stored according to the second command while the program operation according to the first command is being performed, when the program type command indicates the second type.

14. A storage device comprising:
a memory device including a plurality of memory cells; and
a memory controller configured to sequentially store commands to be executed by the memory device, provide the memory device with a first command that is a program command among the commands to be executed, and control the memory device to perform a program operation according to the first command as one of a normal program operation and a cache program operation, depending on whether a second command to be executed next in time to the first command is a program command.

15. The storage device of claim 14, wherein the memory controller provides the memory device with a program initiation command indicating initiation of a program operation corresponding to the first command and data to be stored according to the first command, determines a program type command corresponding to the first command and provides the determined program type command, depending on whether the second command is a program command,
wherein the program type command indicates one of a first type indicating that the program operation is the normal program operation and a second type indicating that the program operation is the cache program operation.

16. The storage device of claim 15, wherein the memory controller:
determines the program type command to indicate the first type, when the second command is a read command or erase command; and
determines the program type command to indicate the second type, when the second command is a program command.

17. The storage device of cam 16, wherein the memory device further includes:
first page buffers coupled to the plurality of memory cells through bit lines, the first page buffers storing data to be stored according to the first command;
second page buffers coupled to the corresponding first page buffers respectively, the second page buffers storing data to be transferred to the first page buffers; and
a program operation processor configured to perform, when the program type command corresponding to the first command is received, a program operation of storing data stored in the first page buffers in the plurality of memory cells.

18. The storage device of claim 17, wherein, when the program type command indicates the first type, the program operation processor stores, in the first page buffers, data to be stored according to a program command to be executed next in time to the first command among the commands to be executed, after the program operation is completed.

19. The storage device of claim 17, wherein, when the program type command indicates the second type, the program operation processor stores data to be stored according to the second command in the second page buffers while the program operation is being performed.

20. The storage device of claim 19, wherein, when the program operation is completed, the program operation processor stores, in the first page buffers, data to be stored according to the second command, which is stored in the second page buffers.
